(19) United States
(12) Patent Application Publication
(10) Pub. No.: US 2025/0189432 A1
(43) Pub. Date: Jun. 12, 2025

(54) ROAD SURFACE CONDITION DETERMINATION DEVICE AND ROAD SURFACE CONDITION DETERMINATION METHOD

(71) Applicant: SK Planet Co., Ltd., Seongnam-si (KR)

(72) Inventors: Joon Sung LEE, Seoul (KR); U Ju GIM, Sejong-si (KR); Chi Yurl YOON, Seoul (KR)

(21) Appl. No.: 18/957,827

(22) Filed: Nov. 24, 2024

(30) Foreign Application Priority Data
Dec. 8, 2023 (KR) 10-2023-0178091
Dec. 14, 2023 (KR) 10-2023-0181447
Dec. 18, 2023 (KR) 10-2023-0184386

(51) Int. Cl. G01N 19/02; G06V 10/774; G06V 10/80; G06V 20/54

(52) U.S. Cl. CPC G01N 19/02; G06V 10/774; G06V 10/80; G06V 20/54

(57) ABSTRACT

The present disclosure relates to a method for determining a road surface condition by using a tire friction sound of a vehicle generated in a road section. Furthermore, the present disclosure relates to a method for determining the road surface condition of a road section in real time by using audio features distributed by frequency bands of an audio signal measured in the road section. Furthermore, the present disclosure relates to a method for reliably determining the road surface condition of a wider road section at a lower cost.

### CROSS-REFERENCE TO RELATED APPLICATIONS

This application is based on and claims priority under 35 U.S.C. 119 to Korean Patent Application No. 10-2023-0178091, filed on Dec. 8, 2023, Korean Patent Application No. 10-2023-0181447, filed on Dec. 14, 2023, and Korean Patent Application No. 10-2023-0184386, filed on Dec. 18, 2023, in the Korean Intellectual Property Office, the disclosure of which is herein incorporated by reference in its entirety.

### BACKGROUND OF THE INVENTION

### Field of the Invention

The present disclosure relates to a method for determining a road surface condition by using a vehicle tire friction sound generated on a road section.

Furthermore, the present disclosure relates to a method for determining the road surface condition of a road section in real time by using audio features distributed by frequency bands of audio signals measured in a road section.

Furthermore, the present disclosure relates to a method for reliably determining the road surface condition of a wider road section at a lower cost.

### Description of the Prior Art

Vehicles may be exposed to hazards while traveling due to abnormal road conditions or road surface conditions. In particular, during the winter season, the risk of accidents may be increased due to road surface conditions such as snow accumulation, freezing of heavy snow or rain, and black ice.

Traditionally, the risk of accidents has been prevented and eliminated by periodically checking road conditions or by, when an abnormal road condition is reported, repairing a road with the abnormal condition or urgently restoring the hazardous road surface.

However, these responses have been inefficient because the responses do not reflect real-time road conditions and are post-event responses.

To solve the problems of the existing methods, a technical solution has been proposed that classifies road surface conditions (e.g., damaged state, temperature/humidity, water film, accumulated snow, icy, etc.) by using data obtained by measuring/analyzing the road surface conditions through optical sensors to enable proactive responses based on the classification result, thereby improving winter road traffic safety.

The prior art has key features of measurement and analysis using expensive optical sensors (e.g., spectral sensors) and has the advantage of high accuracy. However, the prior art is too expensive and have a very narrow application range of less than 1 m. As a result, it is difficult to apply the prior art to wide and long road sections where vehicles drive.

### SUMMARY OF THE INVENTION

The present disclosure has been designed in consideration of the above-described circumstances, and an aspect to be achieved by the present disclosure is to determine a road surface condition by using a tire friction sound of a vehicle generated in a road section.

Furthermore, the present disclosure has been designed in consideration of the above-described circumstances, and an aspect to be achieved by the present disclosure is to determine the road surface condition of a road section in real time by using audio features distributed by frequency bands of audio signals measured in the road section.

Furthermore, the present disclosure has been designed in consideration of the above-described circumstances, and an aspect to be achieved the present disclosure is to propose a new technical solution that can overcome cost-related problems and limitations in application scope of existing technologies and can reliably determine a road surface condition of a wider road section at a lower cost.

A road surface condition determination device, according to a first embodiment of the present disclosure for achieving the above aspects, includes: a memory including instructions; and a processor configured to, by executing the instructions, convert a time-domain signal obtained by measuring a tire friction sound of a vehicle in a road section into a frequency-domain signal, and compare a frequency characteristic of a source waveform, identified from the frequency-domain signal, with a learning value to determine a road surface condition of the road section.

A road surface condition determination method performed by a road surface condition determination device, according to a first embodiment of the present disclosure for achieving the above aspects, includes: a conversion operation of converting a time-domain signal, obtained by measuring a tire friction sound of a vehicle in a road section, into a frequency-domain signal; and a determination operation of comparing a frequency characteristic of a source waveform, identified from the frequency-domain signal, with a learning value to determine a road surface condition of the road section.

A road surface condition determination device, according to a second embodiment of the present disclosure for achieving the above aspects, includes: a memory including instructions; and a processor configured to, by executing the instructions, determine a frequency band of interest for an audio signal measured in a road section based on whether a vehicle is driving in the road section, and determine a road surface condition of the road section from an audio feature extracted from the frequency band of interest.

A road surface condition determination device, according to a third embodiment of the present disclosure for achieving the above aspects, includes: a memory including instructions; and a processor configured to, by executing the instructions, determine a road condition of a road section by using a multimodal model trained on road surface noise collected in the road section by using captured images, collected from multiple devices configured to photograph the road section, and road surface data, collected from an optical sensor configured to photograph the road section.

According to the road surface condition determination device and the road surface condition determination method of the first embodiment of the present disclosure, a road surface condition of a road section may be determined by converting a time-domain signal, obtained by measuring a tire friction sound of a vehicle in the road section, into a frequency-domain signal and comparing a frequency characteristic of a source waveform, identified from the converted frequency-domain signal, with a learning value, thereby enabling a more efficient and accurate determination of a road condition using the tire friction sound of the vehicle passing through the road section.

Furthermore, according to the road surface condition determination device of the second embodiment of the present disclosure, it is possible to more accurately check the road surface condition of a road section in real time by determining different frequency regions of an audio signal as frequency bands of interest, based on the result of checking whether a vehicle is driving in the road section, and comparing an audio feature distributed in each frequency band of interest with learning values categorized by frequency bands

Furthermore, according to the road surface condition determination device of the third embodiment of the present disclosure, a road surface condition may be reliably determined based on a road surface noise generated in a road section, thereby solving cost-related problems and limitations in application scope of existing technologies, while determining and responding to the road surface condition of the entire wider road section at a significantly lower cost.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a road surface condition determination environment according to a first embodiment of the present disclosure;

FIG. 2 illustrates the configuration of a road surface condition determination device according to the first embodiment of the present disclosure;

FIG. 3 illustrates a signal conversion operation according to the first embodiment of the present disclosure;

FIG. 4 is a flowchart illustrating a road surface condition determination method according to the first embodiment of the present disclosure;

FIG. 5 illustrates a road surface condition determination environment according to a second embodiment of the present disclosure;

FIG. 6 illustrates the configuration of a road surface condition determination device according to the second embodiment of the present disclosure;

FIG. 7 illustrates a frequency band of interest according to the second embodiment of the present disclosure;

FIG. 8 is a flowchart illustrating a road surface condition determination method according to the second embodiment of the present disclosure;

FIG. 9 illustrates a road surface condition determination environment according to a third embodiment of the present disclosure;

FIG. 10 illustrates the configuration of a road surface condition determination device according to the third embodiment of the present disclosure; and

FIG. 11 is a flowchart illustrating a road surface condition determination method according to the third embodiment of the present disclosure;

### DETAILED DESCRIPTION OF THE EXEMPLARY EMBODIMENTS

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The terms “include” or “is composed of” in this specification are not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Hereinafter, a first embodiment of the present disclosure will be described with reference to the accompanying drawings.

In the first embodiment of the present disclosure, a road condition determination technology using audio signals is addressed.

In general, the fatality rate of traffic accidents caused by slippery road surfaces is reported to be as high as “1.3 to 1.5 times the fatality rate of traffic accidents caused by dry road surfaces. In particular, the fatality rate of skidding traffic accidents caused by poor road surfaces is reported to be as high as 2.9 times the fatality rate of general traffic accidents.

In other words, it can be seen that a vehicle may be exposed to risks while traveling due to abnormal road conditions or road surface conditions and that, in particular, during the winter season, road surface conditions such as snow accumulation, freezing of snow or rain, and black ice may significantly increase the risk of these accidents.

In this regard, the risk may be prevented and eliminated by periodically checking road conditions or by, when an abnormal road condition is reported, repairing a road with the abnormal condition or urgently restoring the hazardous road surface.

However, these responses have been inefficient because the responses do not reflect real-time road conditions and are post-event responses.

In this regard, various technologies related to road surface condition determination devices have been known to reduce driving accidents by automatically detecting hazard conditions, such as road icing or snow accumulation, and alerting a driver in advance.

However, these technologies mainly use various sensors such as temperature sensors and lasers, or a method in which a person monitors cameras installed at various points on a road, and thus face problems such as relatively high mounting costs, increased labor costs, and frequent malfunctions.

Accordingly, the first embodiment of the present disclosure proposes a new method for determining a road surface condition based on the analysis of an audio signal generated in a road section.

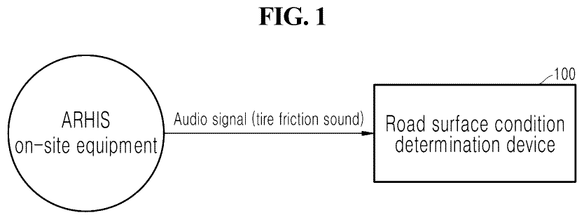

In this regard, FIG. 1 illustrates an exemplary road surface condition determination environment according to the first embodiment of the present disclosure.

As illustrated in FIG. 1, a road surface condition determination environment according to the first embodiment of the present disclosure includes a road surface condition determination device 100 for determining road conditions by using the existing infrastructure of an audio-AI-based road hazard information system (ARHIS).

ARHIS is a solution that uses deep learning to analyze driving noise generated in a road section to determine road surface conditions in real time, thereby supporting automatic detection and identification of road hazards such as icing.

The road surface condition determination device 100 according to the first embodiment of the present disclosure may use the existing infrastructure of ARHIS and, as a result, determine road conditions in real time by using a vehicle tire friction sound on a road section.

The road surface condition determination device 100 may be implemented, for example, in the form of ARHIS on-site equipment (case) accessible via a mobile communication network (e.g., LTE) or a remote server that operates in conjunction with the ARHIS on-site equipment.

Hereinafter, the description will be continued assuming that the road surface condition determination device 100 is implemented in the form of a server, and thus, the ARHIS on-site equipment remotely receives a vehicle tire friction sound measured in a road section and determines a road condition.

When the road surface condition determination device 100 is implemented in the form of a server, the road surface condition determination device 100 may be implemented as, for example, a web server, a database server, or a proxy server. A network load balancing mechanism, or at least one of various types of software, which enables a service device to operate over the Internet or another network, may be installed, thereby allowing the road surface condition determination device 100 to be implemented as a computerized system.

In the road surface condition determination environment according to the first embodiment of the present disclosure, the above-described configuration road conditions may be used determine using a vehicle tire friction sound generated in a road section. Hereinafter, the configuration of the road surface condition determination device 100 for realizing this will be described in more detail.

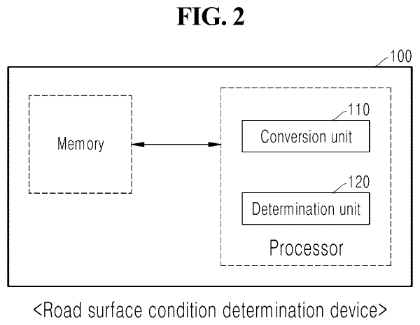

FIG. 2 illustrates the configuration of the road surface condition determination device 100 according to the first embodiment of the present disclosure.

As illustrated in FIG. 2, the road surface condition determination device 100 according to the first embodiment of the present disclosure may include a memory including instructions, and a processor configured to execute the instructions in the memory.

In particular, the processor according to the first embodiment of the present disclosure may include a conversion unit 110, and a determination unit 120 according to functions implemented by the execution of instructions.

The road surface condition determination device 100 according to an embodiment of the present disclosure may efficiently determine road conditions by using vehicle tire friction sounds generated in a road section through the above-described functional elements of the processor. Hereinafter, each functional element configured to realize this will be described in more detail.

The conversion unit 110 is responsible for converting an audio signal, obtained by measuring a vehicle tire friction sound.

More specifically, the conversion unit 110 converts a time-domain signal, obtained by measuring a tire friction sound of a vehicle in a road section, into a frequency-domain signal.

The conversion unit 110 may compare a current composite waveform of the time-domain signal, obtained by measuring the tire friction sound of the vehicle in the road section, with a predefined reference composite waveform. As a result of the comparison, when a waveform change equal to or greater than a threshold value is identified from the reference composite waveform, the conversion unit 110 may convert the time-domain signal into a frequency-domain signal for road condition determination.

The reference composite waveform may be defined as a composite waveform of at least one of, for example, a time-domain signal measured at each set interval in the road section, and a time-domain signal measured in a previous road section adjacent to the road section.

In conclusion, when, as a result of comparing the current composite waveform of a time-domain signal, obtained by measuring a tire friction sound of a vehicle in a road section, with the predefined reference composite waveform, a waveform change equal to or greater than the threshold value is identified from the reference composite waveform as described above, the conversion unit 110 recognizes this as an event situation in which a significant change in the road condition has occurred, and converts the time-domain signal into a frequency-domain signal for road surface condition determination.

Converting a time-domain signal into a frequency-domain signal only when a waveform change equal to or greater than the threshold value is identified from the reference composite waveform may be understood as being intended to prevent unnecessarily frequent signal conversion operations, thereby optimizing resource consumption associated with signal conversion.

According to the first embodiment of the present disclosure, the sensitivity of a signal conversion operation may be adjusted by setting a threshold value regarding waveform changes. The sensitivity adjustment may be adaptively made through a threshold value that is differently set in response to seasonal or weather-specific changes in the level of accident risk due to road surface conditions.

For example, during the winter season, when the risk of accidents is relatively high due to road surface conditions such as snow accumulation, freezing of snow or rain, and black ice, a low threshold value for waveform changes may be set, thereby controlling a signal conversion operation for road surface condition determination to be performed even in the case of a small waveform change.

The determination unit 120 is responsible for determining road conditions.

More specifically, when the time-domain signal obtained by measuring the tire friction sound of the vehicle in the road section is converted to a frequency-domain signal, the determination unit 120 may determine the road surface condition of the road section by using the converted frequency-domain signal.

The determination unit 120 may determine the road surface condition of the road section by comparing a frequency characteristic of a source waveform, identified from the frequency-domain signal, with a learning value.

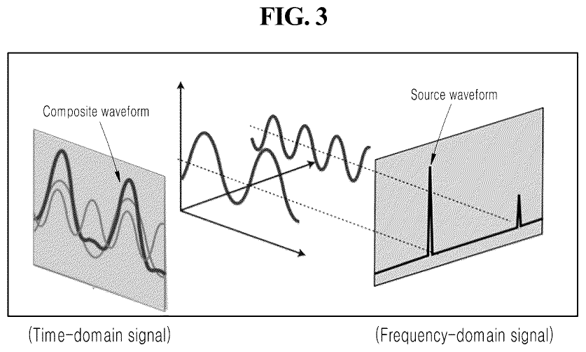

The frequency characteristic of the source waveform identified from the frequency-domain signal may be understood as a combination of a frequency region of each source waveform constituting a composite waveform in a time domain and the magnitude of amplitude in the frequency region, as in FIG. 3. The frequency characteristic of the source waveform may vary depending on road conditions.

To compare, as described above, the frequency characteristic of a source waveform identified from the frequency-domain signal with the learning value, the determination unit 120 may learn a frequency characteristic for each road condition, for example, through deep learning.

In this regard, the determination unit 120 defines road conditions that can be determined in the road section, and with respect to each defined road condition, learns frequency characteristic of a source waveform, identified from the frequency-domain signal, separately for each vehicle speed interval.

The reason for learning frequency characteristic of a source waveform, identified from the frequency-domain signal, separately for each vehicle speed interval with respect to each road state is that the frequency characteristic of a tire friction sound may vary depending on the vehicle's speed, even for the same road condition.

As a result, according to the first embodiment of the present disclosure, by learning a frequency characteristic of tire friction sound for each road condition, which can be determined in a road section, separately for each vehicle speed interval, it is possible to more accurately determine road conditions from tire friction sounds of vehicles passing through the road section at different speeds.

As described above, according to the configuration of the road surface condition determination device 100 according to the first embodiment of the present disclosure, it can be seen that the road surface condition of a road section may be determined by converting a time-domain signal, obtained by measuring a tire friction sound of a vehicle in the road section, into a frequency-domain signal and comparing a frequency characteristic of a source waveform, identified from the converted frequency-domain signal, with a learning value, thereby more efficiently and accurately determining road conditions by using the tire friction sound of a vehicle passing through the road section.

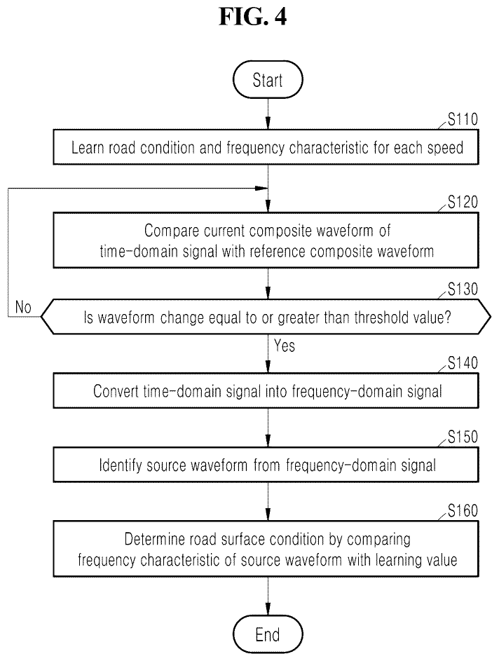

Hereinafter, a road surface condition determination method according to the first embodiment of the present disclosure will be described with reference to FIG. 4.

For ease of description, the following description will refer to the road surface condition determination device 100, described with reference to FIG. 2, as an entity for performing the road surface condition determination method.

The road surface condition determination device 100 learns a frequency characteristic for each road condition in order to compare frequency characteristic of a source waveform, identified from a frequency-domain signal, with a learned value (S110).

The road surface condition determination device 100 may define road conditions that can be determined in a road section, and with respect to each defined road condition, may learn the frequency characteristic of the source waveform, identified from the frequency-domain signal, separately for each vehicle speed interval.

The reason for learning the frequency characteristic of the source waveform, identified from the frequency-domain signal, separately for each vehicle speed interval is that the frequency characteristic of a tire friction sound may vary depending on the vehicle's speed, even for the same road condition.

The frequency characteristic of the source waveform identified from the frequency-domain signal may be understood as a combination of a frequency region of each source waveform constituting a composite waveform in a time domain and the magnitude of amplitude in the frequency region, as in FIG. 3. The frequency characteristic of the source waveform may vary depending on road conditions.

As a result, according to the first embodiment of the present disclosure, by learning the frequency characteristic of tire friction sound for each road condition, which can be determined in a road section, separately for each vehicle speed interval, it is possible to more accurately determine road conditions from tire friction sounds of vehicles passing through the road section at different speeds.

Furthermore, the road surface condition determination device 100 converts a time-domain signal, obtained by measuring the tire friction sound of a vehicle in the road section, into a frequency-domain signal (S120-S140).

The road surface condition determination device 100 may compare a current composite waveform of the time-domain signal, obtained by measuring the tire friction sound of the vehicle in the road section, with a predefined reference composite waveform. As a result of the comparison, when a waveform change equal to or greater than a threshold value is identified from the reference composite waveform, the road surface condition determination device 100 may convert the time-domain signal into a frequency-domain signal for road condition determination.

The reference composite waveform may be defined as a composite waveform of at least one of, for example, a time-domain signal measured at each set interval in the road section, and a time-domain signal measured in a previous road section adjacent to the road section.

In conclusion, when, as a result of comparing the current composite waveform of a time-domain signal, obtained by measuring a tire friction sound of a vehicle in a road section, with the predefined reference composite waveform, a waveform change equal to or greater than the threshold value is identified from the reference composite waveform as described above, the road surface condition determination device 100 recognizes this as an event situation in which a significant change in the road condition has occurred, and converts the time-domain signal into a frequency-domain signal for road surface condition determination.

Converting a time-domain signal into a frequency-domain signal only when a waveform change equal to or greater than the threshold value is identified from the reference composite waveform may be understood as being intended to prevent unnecessarily frequent signal conversion operations, thereby optimizing resource consumption associated with signal conversion.

According to the first embodiment of the present disclosure, the sensitivity of a signal conversion operation may be adjusted by setting a threshold value regarding waveform changes. The sensitivity adjustment may be adaptively made through a threshold value that is differently set in response to seasonal or weather-specific changes in the level of accident risk due to road surface conditions.

For example, during the winter season, when the risk of accidents is relatively high due to road surface conditions such as snow accumulation, freezing of snow or rain, and black ice, a low threshold value for waveform changes may be set, thereby controlling a signal conversion operation for road surface condition determination to be performed even in the case of a small waveform change.

Subsequently, when the time-domain signal obtained by measuring the tire friction sound of the vehicle in the road section is converted to a frequency-domain signal, the road surface condition determination device 100 may determine the road surface condition of the road section by using the converted frequency-domain signal (S150-S160).

The road surface condition determination device 100 may determine the road surface condition of the road section by comparing a frequency characteristic of a source waveform, identified from the frequency-domain signal, with a learning value.

In other words, the road surface condition determination device 100 determines the road condition by comparing the learning value, obtained by learning the frequency characteristic of tire friction sound for each road condition separately for each vehicle speed interval, with the frequency characteristic of the source waveform identified from the frequency-domain signal.

As described above, according to the road surface condition determination method according to the first embodiment of the present disclosure, it can be seen that the road surface condition of a road section may be determined by converting a time-domain signal, obtained by measuring a tire friction sound of a vehicle in the road section, into a frequency-domain signal and comparing a frequency characteristic of a source waveform, identified from the converted frequency-domain signal, with a learning value, thereby more efficiently and accurately determining road conditions by using the tire friction sound of a vehicle passing through the road section.

Hereinafter, a second embodiment of the present disclosure will be described with reference to the accompanying drawings.

The second embodiment of the present disclosure addresses a technology for determining, based on a deep learning model, road surface conditions from an audio signal measured in a road section.

In this regard, a vehicle may be exposed to risks due to road surface conditions while traveling. Heavy rain during the summer season, in particular, road surface conditions such as snow accumulation, freezing of snow or rain, and black ice during the winter season may significantly increase the risk of accidents.

In the past, road surface conditions were periodically checked by using video or the like. Alternatively, only when an abnormal road surface condition was reported, an on-site visit to a road with the abnormal condition would be conducted to check the road surface condition.

However, these responses could not check the road surface condition in real time, so a follow-up response was inevitable. Therefore, these responses were not efficient in hazard warning and accident prevention based on road surface conditions.

Therefore, in order to efficiently support hazard warning and accident prevention based on the road surface conditions, it is necessary to seek a new method that can check the road surface condition of a road section in real time.

Therefore, the second embodiment of the present disclosure proposes a new method for determining the road surface condition of a road section in real time by using audio features distributed in each frequency band of an audio signal measured in the road section.

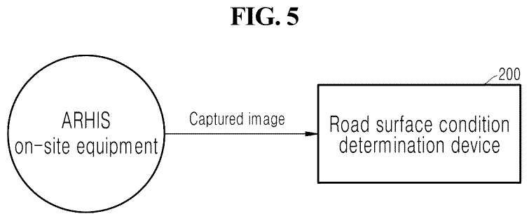

In this regard, FIG. 5 illustrates an exemplary road surface condition determination environment according to the second embodiment of the present disclosure.

As illustrated in FIG. 5, the road surface condition determination environment according to the second embodiment of the present disclosure includes a road surface condition determination device 200 for determining road conditions from an audio signal measured in a road section.

The road surface condition determination device 200 may acquire an audio signal of a road section by using the existing infrastructure of an audio-AI-based road hazard information system (ARHIS), and determine road conditions from the audio signal by using a pre-trained deep learning model.

ARHIS is a solution that uses deep learning to analyze driving noise generated in a road section to determine road surface conditions in real time, thereby supporting automatic detection and identification of road hazards such as icing.

The road surface condition determination device 200 may be implemented, for example, in the form of ARHIS on-site equipment (case) accessible via a mobile communication network (e.g., LTE) or a remote server that operates in conjunction with the ARHIS on-site equipment.

Hereinafter, the description will be continued assuming that the road surface condition determination device 200 is implemented in the form of a server, and thus, the ARHIS on-site equipment remotely receives an audio signal measured in a road section and determines a road condition from the audio signal.

When the road surface condition determination device 200 is implemented in the form of a server, the road surface condition determination device 200 may be implemented as, for example, a web server, a database server, or a proxy server. A network load balancing mechanism, or at least one of various types of software, which enables a service device to operate over the Internet or another network, may be installed, thereby allowing the road surface condition determination device 200 to be implemented as a computerized system.

In the road surface condition determination environment according to the second embodiment of the present disclosure, the above-described configuration may be used to determine road conditions from frequency band-specific features of an audio signal measured in a road section. Hereinafter, the configuration of the road surface condition determination device 200 for realizing this will be described in more detail.

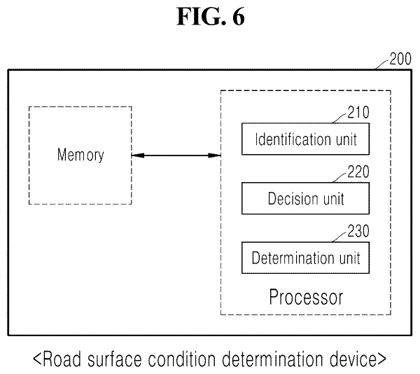

FIG. 6 illustrates the configuration of the road surface condition determination device 200 according to the second embodiment of the present disclosure.

As illustrated in FIG. 6, the road surface condition determination device 200 according to the second embodiment of the present disclosure may include a memory including instructions, and a processor configured to execute the instructions in the memory.

In particular, the processor according to the second embodiment of the present disclosure may include an identification unit 210, a decision unit 220, and a determination unit 230 according to functions implemented by the execution of the instructions.

The road surface condition determination device 200 according to an embodiment of the present disclosure may determine road surface conditions from frequency band-specific audio features of an audio signal measured in a road section through the above-described functional elements of the processor. Hereinafter, each functional element for realizing this will be described in more detail.

The identification unit 210 is responsible for identifying whether a vehicle is driving.

More specifically, when an audio signal measured in a road section is received, the identification unit 210 may identify whether a vehicle is driving in the road section by using the received audio signal.

In this case, the identification unit 210 may identify whether the vehicle is driving in the road section from audio features extracted from a specific frequency band, which is a predefined valid frequency band, among frequency bands of the audio signal.

The valid frequency band refers to a valid frequency band, in which audio features in the driving and non-driving states of the vehicle are distributed, among all frequency bands of the audio signal, and may be filtered through a band-pass filter (BPF) targeting the frequency band.

In summary, the identification unit 210 filters a specific frequency band, in which audio features of the driving and the non-driving states of a vehicle are distributed, among all frequency bands of an audio signal as a valid frequency band, extracts audio features from the filtered valid frequency band, and identifies whether the vehicle is driving from the extracted audio features.

The decision unit 220 is responsible for determining a frequency band of interest.

More specifically, when whether a vehicle is driving in a road section is identified, the decision unit 220 determines a frequency band of interest for an audio signal measured in the road section, based on the identification result.

The decision unit 220 may determine the frequency band of interest to be different frequency regions that are filtered from the valid frequency band based on the result of identifying whether the vehicle is driving.

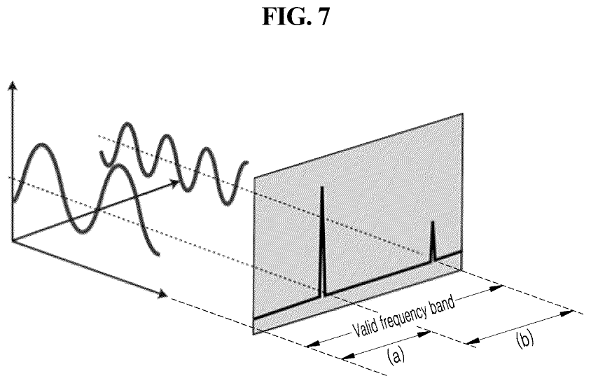

In other words, when a vehicle driving state is identified in the road section, the decision unit 220 additionally filters a partial frequency band, in which audio features (tire friction sound and vehicle engine sound) related to vehicle driving are distributed, within the valid frequency band that has been pre-filtered, such as in FIG. 7 (a), and determines the partial frequency band as a frequency band of interest.

On the other hand, in the case where a vehicle non-driving state is identified in the road section, the decision unit 220 additionally filters another frequency band, in which the audio features related to the non-driving of the vehicle are distributed, such as in FIG. 7 (b), from the pre-filtered valid frequency band, and determines the other frequency as a frequency band of interest.

The audio features related to the non-driving of the vehicle may refer to any sound/noise other than the tire friction sound and the vehicle engine sound described above, and may be understood as features, distinctly different from those on a clear day, such as subtle vibration sound occurring while waiting during rainfall, or vibration sound caused by rain falling on on-site equipment which measures an audio signal.

The determination unit 230 is responsible for determining road surface conditions.

More specifically, when a frequency band of interest is determined from an audio signal based on whether a vehicle is driving, the determination unit 230 determines a road surface condition of a road section from audio features extracted from the determined frequency band of interest.

In this case, the determination unit 230 extracts audio features distributed in the frequency band of interest, and compares the extracted audio features with frequency band-specific learning values to determine the road surface condition of the road section.

To this end, the determination unit 230 constructs a deep learning model that learns audio features according to road surface conditions of a road section, separately for each frequency band of an audio signal.

In summary, the determination unit 230 may extract audio features from a frequency band of interest determined to be different frequency regions of an audio signal and compare the extracted audio features with deep learning-based learning values distinguished according to frequency bands, thereby determining the road surface condition of a road section in real time.

As described above, it can be seen that, according to the configuration of the road surface condition determination device 200 according to the second embodiment of the present disclosure, it is possible to efficiently check the road surface condition of a road section in real time by determining different frequency regions of an audio signal as frequency bands of interest according to the result of identifying whether a vehicle is driving in the road section, and comparing audio features distributed in each frequency band of interest with learning values distinguished according to frequency bands.

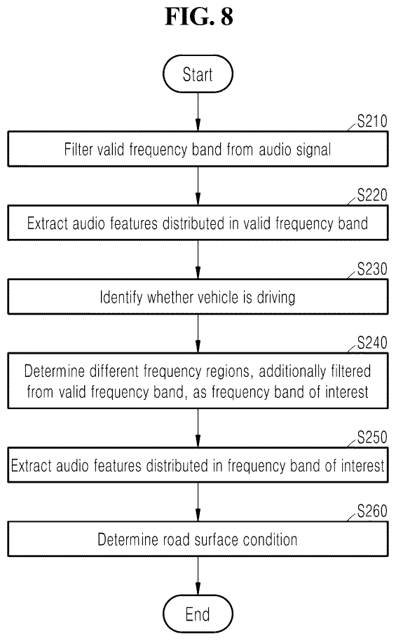

Hereinafter, a road surface condition determination method according to the second embodiment of the present disclosure will be described with reference to FIG. 8.

For ease of description, the following description will refer to the road surface condition determination device 200, described with reference to FIG. 6, as an entity for performing the road surface condition determination method.

When an audio signal measured in a road section is received, the road surface condition determination device 200 may identify whether a vehicle is driving in the road section by using the received audio signal (S210-S230).

In this case, the road surface condition determination device 200 may identify whether the vehicle is driving in the road section from audio features extracted from a specific frequency band, which is a predefined valid frequency band, among frequency bands of the audio signal.

The valid frequency band refers to a valid frequency band, in which audio features in the driving and non-driving states of the vehicle are distributed, among all frequency bands of the audio signal, and may be filtered by a band-pass filter (BPF) targeting the frequency band.

In summary, the road surface condition determination device 200 filters a specific frequency band, in which audio features of the driving and the non-driving states of a vehicle are distributed, among all frequency bands of an audio signal as a valid frequency band, extracts audio features from the filtered valid frequency band, and identifies whether the vehicle is driving from the extracted audio features.

Then, when whether the vehicle is driving in the road section is identified, the road surface condition determination device 200 determines a frequency band of interest for an audio signal measured in the road section, based on the identification result (S240).

The road surface condition determination device 200 may determine the frequency band of interest to be different frequency regions that are filtered from the valid frequency band based on the result of identifying whether the vehicle is driving.

In other words, when a vehicle driving state is identified in the road section, the road surface condition determination device 200 additionally filters a partial frequency band, in which audio features (tire friction sound and vehicle engine sound) related to vehicle driving are distributed, within the valid frequency band that has been pre-filtered, such as in FIG. 7 (a), and determines the partial frequency band as the frequency band of interest.

On the other hand, in the case where a vehicle non-driving state is identified in the road section, the road surface condition determination device 200 additionally filters another frequency band, in which the audio features related to the non-driving of the vehicle are distributed, such as in FIG. 7 (b), from the pre-filtered valid frequency band, and determines the other frequency band as a frequency band of interest.

The audio features related to the non-driving of the vehicle may refer to any sound/noise other than the tire friction sound and the vehicle engine sound described above, and may be understood as features that is distinctly different from those on a clear day, such as subtle vibration sound while waiting during rainfall, or vibration sound caused by rain falling on on-site equipment which measures an audio signal.

Subsequently, when a frequency band of interest is determined from the audio signal based on whether the vehicle is driving, the road surface condition determination device 200 determines the road surface condition of the road section from audio features extracted from the determined frequency band of interest (S250-S260).

In this case, the road surface condition determination device 200 extracts audio features distributed in the frequency band of interest, and compares the extracted audio features with a learning value for each frequency band to determine the road surface condition of the road section.

To this end, the road surface condition determination device 200 constructs a deep learning model that learns audio features according to road surface conditions of a road section, separately for each frequency band of an audio signal.

In summary, the road surface condition determination device 200 may extract audio features from a frequency band of interest determined to be different frequency regions of an audio signal and compare the extracted audio features with deep learning-based learning values distinguished according to frequency bands, thereby determining the road surface condition of a road section in real time.

As described above, it can be seen that, according to the configuration of the road surface condition determination method according to the second embodiment of the present disclosure, it is possible to efficiently check the road surface condition of a road section in real time by determining different frequency regions of an audio signal as frequency bands of interest according to the result of identifying whether a vehicle is driving in the road section, and comparing audio features distributed in each frequency band of interest with learning values distinguished according to frequency bands.

Hereinafter, a third embodiment of the present disclosure will be described with reference to the accompanying drawings.

The third embodiment of the present disclosure addresses a technology for determining road surface conditions by using a model.

Recently, the rapid increase in the number of vehicles has led to an increase in the number of serious vehicle accidents on the roads. The risk of vehicle accidents may be higher depending on the road surface conditions of roads on which vehicles are driving. In particular, during the winter season, road surface conditions such as snow accumulation, freezing of snow or rain, and black ice may increase the risk of these accidents.

Traditionally, the risk of accidents has been prevented and eliminated by periodically checking road conditions or by, when an abnormal road condition is reported, repairing a road with the abnormal condition or urgently restoring the hazardous road surface.

However, the existing method has been inefficient because the method does not reflect real-time road conditions and is a post-event response.

In this regard, to solve the problems of the existing methods, a technical solution has been proposed that classifies road surface conditions (e.g., damaged state, temperature/humidity, water film, accumulated snow, icy, etc.) by using data obtained by measuring/analyzing the road surface conditions through optical sensors to enable proactive responses based on the classification result, thereby improving winter road traffic safety.

The prior art has key features of measurement and analysis using expensive optical sensors (e.g., spectral sensors) and has the advantage of high accuracy. However, the prior art is too expensive and have a very narrow application range of less than 1 m. As a result, it is difficult to apply the prior art to wide and long road sections where vehicles drive.

Accordingly, an aspect of the present disclosure is to propose a new technical solution that can overcome the cost-related problems and limitations in application scope of existing technologies and can reliably determine the road surface condition of a wider road section at a lower cost.

More specifically, the present disclosure proposes a specific technical solution for reliably determining road surface conditions based on road noise generated in a road section.

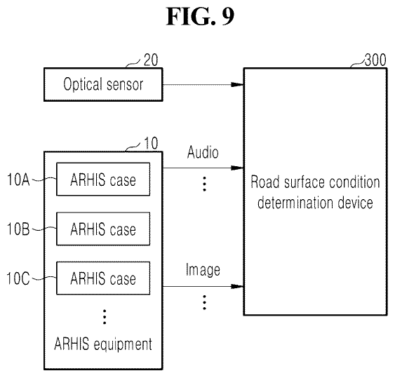

In this regard, FIG. 9 illustrates an exemplary road surface condition determination environment according to the third embodiment of the present disclosure.

As illustrated in FIG. 9, in the road surface condition determination environment according to the third embodiment of the present disclosure, road surface noise generated in a road section may be detected/acquired using the existing infrastructure of an audio-AI-based road hazard information system (ARHIS), and may be used.

ARHIS is a solution that detects/acquires road surface noise/tire friction sound generated in/around a road section and uses the same to automatically detect and identify road hazards. Through a structure in which ARHIS cases 10A, 10B, 10C, . . . are installed at regular intervals along the entire road section, ARHIS allows each ARHIS case to detect/acquire road surface noise/tire friction sound generated in a road region designated for each ARHIS case and to use the road surface noise/tire friction sound.

In the present disclosure, each of the ARHIS cases 10A, 10B, 10C, . . . of the ARHIS may support an imaging function for capturing an image of a road region designated for each ARHIS case.

In other words, the present disclosure may use multiple devices that are installed at regular intervals in the entire road section so as to capture an image of a designated road region of the road section and acquire sound/audio (e.g., road surface noise/tire friction sound) generated in the road section, and existing infrastructure, i.e., the ARHIS cases 10A, 10B, 10C, . . . may be used as the multiple devices.

Furthermore, as illustrated in FIG. 9, in the road surface condition determination environment according to the third embodiment of the present disclosure, an optical sensor 20 (e.g., a spectral sensor) may be used, and road surface data obtained therefrom may also be acquired/used.

In other words, the road surface condition determination environment according to a third embodiment of the present disclosure implements a technology for determining a road surface condition in the entire road section (e.g., several kilometers to tens of kilometers) by using multiple ARHIS elements 10A, 10B, 10C, . . . and one or a small number of optical sensors 20 (e.g., spectral sensors), and may include a road surface condition determination device 300 as an element for this purpose.

The road surface condition determination device 300 may be implemented in one or each of the ARHIS cases 10A, 10B, 10C, . . . of the ARHIS accessible via a mobile communication network (e.g., LTE or 5G), or may be implemented in the form of a remote server that operates in conjunction with the ARHIS cases 10A, 10B, 10C, . . . .

Hereinafter, the description will be made on the premise that the road surface condition determination device 300 is implemented in the form of a server, wherein the road surface condition determination device 300 remotely receives captured images i.e., image data, and road surface noise/tire friction sound, i.e., audio data, from each of the ARHIS cases 10A, 10B, 10C, . . . of the ARHIS (furthermore, receives road surface data from the optical sensor 20 (e.g., a spectral sensor), and use the received data to determine the road surface condition of a road section (e.g., several kilometers to tens of kilometers).

When the road surface condition determination device 300 is implemented in the form of a server, the road surface condition determination device 300 may be implemented as, for example, a web server, a database server, or a proxy server. A network load balancing mechanism, or at least one of various types of software that enables a service device to operate over the Internet or another network, may be installed, thereby allowing the road surface condition determination device 300 to be implemented as a computerized system.

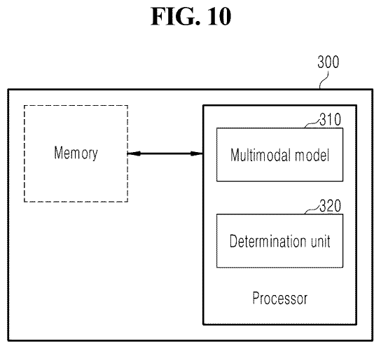

Hereinafter, a configuration of the road surface condition determination device 300 according to the third embodiment of the present disclosure will be described in detail with reference to FIG. 10.

As illustrated in FIG. 10, the road surface condition determination device 300 according to the third embodiment of the present disclosure may include a memory including instructions, and a processor configured to execute the instructions in the memory.

In particular, the processor according to the third embodiment of the present disclosure may include a multimodal model 310 and a determination unit 320 according to functions implemented by the execution of the instructions.

The road surface condition determination device 300 according to the third embodiment of the present disclosure may use the above-described functional elements of the processor to determine a road surface condition, based on road surface noise generated in a road section. A more specific description of each functional element for realizing this will be described below.

The multimodal model 310 is a model generated/constructed to determine road surface conditions based on road surface noise generated in a road section by learning audio data (road surface noise/tire friction sound) collected from the road section by using image data (captured images) collected from multiple devices which photograph the road section, for example, the ARHIS cases 10A, 10B, 10C, . . . , and road surface data collected from the optical sensor 20 (e.g., a spectral sensor) which photographs the road section.

As described above, the road surface condition determination device 300 according to the third embodiment of the present disclosure has a structure that uses the multiple ARHIS cases 10A, 10B, 10C, . . . covering the entire road section (e.g., several kilometers to tens of kilometers) and one (or a small number of) optical sensor(s) 20 (e.g., a spectral sensor).

In a specific embodiment, in the present disclosure, a label, generated by synthesizing captured images collected from the multiple ARHIS cases (10A, 10B, 10C, . . . ) under multiple different road surface conditions, road surface data (e.g., temperature/humidity, water film, snow accumulation, icing, etc.) collected from the optical sensor 20 (e.g., a spectral sensor), and weather data (e.g., temperature/humidity, dew point, precipitation, snowfall, etc.) at each collection time point, may be assigned to road surface noise/tire friction sound in a road section from the multiple ARHIS cases (10A, 10B, 10C, . . . ) at each collection time point.

In the present disclosure, the multimodal model 310 may be generated by learning training data labeled by assigning the label, generated by synthesizing the image/road surface data/weather data, to the road surface noise/tire friction sound as described above, that is, data on the labeled road surface noise/tire friction sound.

In this way, the multimodal model 310 for determining road surface conditions based on road surface noise may be generated/constructed by learning training data of road surface noise/tire friction sound labeled by synthesizing captured images collected from the multiple ARHIS cases (10A, 10B, 10C, . . . ) covering the entire road section (e.g., several kilometers to tens of kilometers), road surface data collected from one (or a small number of) optical sensor(s) 20 (e.g., a spectral sensor), and weather data.

The determination unit 320 is responsible for determining the road surface condition of a road section by using the multimodal model 310 described above.

In a specifical embodiment, the determination unit 320 may obtain each road surface condition prediction result (e.g., whether the road surface is icy, etc.) from the multimodal model 310 by inputting, into the multimodal model 310, road surface noise data acquired for each designated road region of a road section at the time of determining road surface conditions (e.g., periodically or at set events), that is, road surface noise/tire friction sound data obtained from the multiple ARHIS cases 10A, 10B, 10C, . . . covering the entire road section (e.g., several kilometers to tens of kilometers).

In addition, the determination unit 320 may obtain road surface data (e.g., measurement/analysis results of temperature/humidity, water film, snow accumulation, icing, etc.) from one (or a small number of) optical sensor(s) 20 (e.g., a spectral sensors), installed in the road section, at the time of determining the current road surface condition (e.g., periodically or at set events).

Accordingly, the determination unit 320 may finally determine the road surface condition of the road section through post-processing using each road surface condition prediction result (e.g., icy, etc.) from the multimodal model 310 and the road surface data (e.g., measurement/analysis results of temperature/humidity, water film, snow accumulation, icing, etc.) obtained from the optical sensor 20 (e.g., a spectral sensor).

In this regard, an embodiment of the post-processing performed by the determination unit 320 is described as follows.

Specifically, the determination unit 320 may input data on each road surface noise/tire friction sound, acquired from each of the multiple ARHIS cases 10A, 10B, 10C, . . . installed along the entire road section (e.g., several kilometers to tens of kilometers), into the multimodal model 310 to obtain road condition prediction results for each road region of the entire road section (e.g., several kilometers to tens of kilometers) from the multimodal model 310.

Accordingly, the determination unit 320 may compare, between adjacent road regions, road surface condition prediction results for each road region obtained as described above to determine the consistency of the road surface condition prediction results between adjacent road regions.

For example, when the road surface condition prediction results for adjacent road regions show that one road region is predicted to have an icy or black ice road surface condition while the adjacent road region is predicted to have a non-icy or black ice-free road surface condition, the consistency of road surface condition prediction results between the adjacent road regions may be determined to be low.

When the consistency of road surface condition prediction results between adjacent road regions is low, it may may be considered relatively unreasonable to apply road surface data (e.g., measurement/analysis results of temperature, humidity, water film, snow accumulation, icing, etc.) acquired from one (or a small number of) optical sensor(s) (20, e.g., a spectral sensor) to the overall condition of the road section (e.g., several kilometers to tens of kilometers).

On the other hand, when the consistency of road surface condition prediction results between adjacent road regions are high, it may be considered relatively easy to apply the road surface data (e.g., measurement/analysis results of temperature/humidity, water film, snow accumulation, icing, etc.) obtained from one (or a small number of) optical sensor(s) 20 (e.g., a spectral sensor) to the overall condition of the road section (e.g., several kilometers to tens of kilometers).

In this regard, based on the consistency of road surface condition prediction results between adjacent road regions, which is determined by comparing, between adjacent regions, road surface condition prediction results for each road region obtained as described above, the determination unit 320 may perform weighted processing in which the greater (higher) the consistency, the greater the percentage of road surface data obtained from the optical sensor 20 (e.g., a spectral sensor) is used in the final determination of the road surface condition.

For example, the determination unit 320 may reflect the road surface data, obtained from the optical sensor 20 (e.g., a spectral sensor), with a high use percentage (e.g., 50-70%), in a road surface condition prediction result obtained from the multimodal model 310 to make a final determination of the road surface condition.

On the other hand, based on the consistency of the road surface condition prediction results between adjacent road regions, which is determined by comparing, between adjacent road regions, the road surface condition prediction results for each road region obtained as described above, the determination unit 320 may perform weighted processing in which the smaller (lower) the consistency, the lower the percentage of road surface data obtained from the optical sensor 20 (e.g., a spectral sensor) is used in the final determination of the road surface condition.

For example, the determination unit 320 may reflect the road surface data, obtained from the optical sensor 20 (e.g., a spectral sensor), with a low use percentage (e.g., 0-20%), in a road surface condition prediction result obtained from the multimodal model 310 to make a final determination of the road surface condition.

As described above, the third embodiment of the present disclosure realizes a specific technical configuration for reliably determining a road surface condition based on road surface noise generated in a road section by determining the road surface condition of the road section by using the multimodal model 310 trained on road noise surface labeled with captured mages in the road section, road surface data, weather data, and the like.

In particular, the present disclosure may use one (or a small number) of high-cost optical sensor(s) 20 (e.g., a spectral sensor) and the multimodal model 310 trained to specialize in the present disclosure by utilizing a large number of relatively low-cost captured images to determine the road surface condition of the entire road section (e.g., several kilometer to tens of kilometers), wherein the reliability/accuracy of the road condition determination is improved through post-processing (e.g., weighted processing based on consistency) using road condition prediction results from the multimodal model 310 and road surface data from the optical sensor 20 (e.g., a spectral sensor).

Thus, according to the third embodiment of the present disclosure, by reliably determining a road surface condition based on road noise generated in a road section, it is possible to solve cost-related problems and limitation in application scope of existing technologies, while determining/responding to the road surface condition of the entirety wider road section at a significantly lower cost.

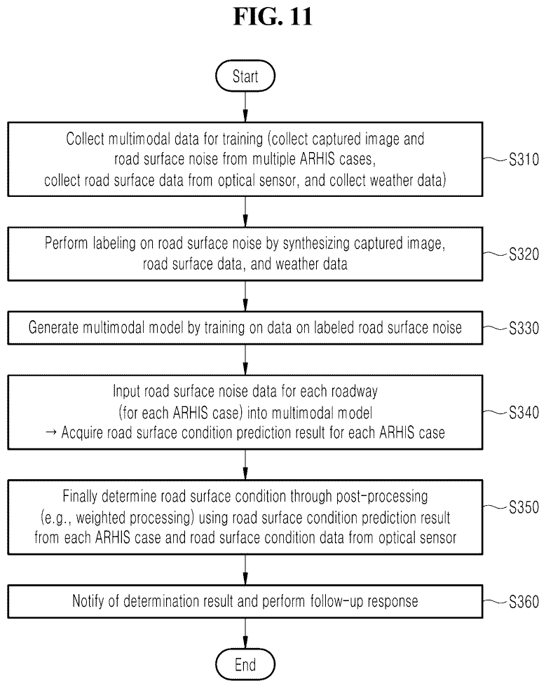

Hereinafter, a road surface condition determination method according to the third embodiment of the present disclosure will be described with reference to FIG. 11.

For ease of description, the following description will refer to the road surface condition determination device 300, described with reference to FIG. 10, as an entity for performing the road surface condition determination method.

According to the road surface condition determination method of the present disclosure, the road surface condition determination device 300 collects multimodal data to train the multimodal model 310 configured to determine a road surface condition based on road surface noise (S310).

Specifically, the road surface condition determination device 300 may collect images and road surface noise/tire friction sound data from the multiple ARHIS cases 10A, 10B, 10C, . . . covering an entire road section (e.g., several kilometers to tens of kilometers), collect road surface data from one (or a small number of) optical sensor(s) 20 (e.g., a spectral sensor), and furthermore collect weather data (S310).

According to the road surface condition determination method of the present disclosure, the road surface condition determination device 300 may, using the multimodal data collected as described above, assign a label generated by synthesizing the captured images/road surface data/weather data to road surface noise/tire friction sound (S320), and train the multimodal model 310 by using data on the labeled road noise/tire friction sound to generate/construct the multimodal model 310 configured to determine a road surface condition based on the road surface noise (S330).

According to the road surface condition determination method of the present disclosure, the road surface condition determination device 300 may determine the road condition of the road section by using the multimodal model 310 described above (S340, S350).

In a specifical embodiment, according to the road surface condition determination method of the present disclosure, the road surface condition determination device 300 may obtain a road surface condition prediction result (e.g., whether the road surface is icy, etc.) for each of the ARHIS cases 10A, 10B, 10C, . . . (for each road region) from the multimodal model 310 by inputting, into the multimodal model 310, road surface noise data acquired for each designated road region of a road section at the time of determining road surface conditions (e.g., periodically or at set events), that is, road surface noise/tire friction sound data obtained from the multiple ARHIS cases 10A, 10B, 10C, . . . covering the entire road section (e.g., several kilometers to tens of kilometers) (S340).

The road surface condition determination device 300 may obtain road surface data (e.g., measurement/analysis results of temperature/humidity, water film, snow accumulation, icing, etc.) from one (or a small number of) optical sensor(s) 20 (e.g., a spectral sensor), installed in the road section, at the time of determining the current road surface condition (e.g., periodically, or at a set event).

According to the road surface condition determination method of the present disclosure, the road surface condition determination device 300 may finally determine the road surface condition of the road section through post-processing (weighted processing) using each road surface condition prediction result (e.g., icy, etc.) from the multimodal model 310 and the road surface data (e.g., measurement/analysis results of temperature/humidity, water film, snow accumulation, icing, etc.) obtained from the optical sensor 20 (e.g., a spectral sensor) in operation S340 (S350).

For example, based on the consistency of road surface condition prediction results between adjacent road regions, which is determined by comparing, between adjacent regions, road surface condition prediction results for each road region obtained as described above, the road surface condition determination device 300 may finally determine a road surface condition by performing weighted processing in which: the greater (higher) the consistency, the greater the percentage of road surface data obtained from the optical sensor 20 (e.g., a spectral sensor) is used in the final determination of the road surface condition; and the smaller (lower) the consistency, the lower the percentage of road surface data obtained from the optical sensor 20 (e.g., a spectral sensor) is used in the final determination of the road surface condition (S350).

According to the road surface condition determination method of the present disclosure, the road surface condition determination device 300 may perform a predetermined response procedure (e.g., generating an alert, etc.) in response to the result of the final road surface condition determination in operation S350 (S360).

As described above, the third embodiment of the present disclosure realizes a specific technical configuration for reliably determining the road surface condition based on road surface noise generated in a road section by using AI (e.g., a multimodal model) that has been trained on the road surface noise in the road section by using images, obtained by photographing the entire road section by road region, and road surface data, collected from one optical sensor.

Thus, according to the third embodiment of the present disclosure, by reliably determining a road surface condition based on road noise generated in a road section, it is possible to solve cost-related problems and limitation in application scope of existing technologies, while determining/responding to the road surface condition of the entirety wider road section at a significantly lower cost.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc., in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or subcombinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

What is claimed is:

1. A road surface condition determination device comprising:
a memory comprising instructions; and
a processor configured to, by executing the instructions, convert a time-domain signal obtained by measuring a tire friction sound of a vehicle in a road section into a frequency-domain signal, and compare a frequency characteristic of a source waveform, identified from the frequency-domain signal, with a learning value to determine a road surface condition of the road section.

2. The road surface condition determination device of claim 1, wherein the processor is configured to convert the time-domain signal into the frequency-domain signal in case that, as a result of comparing a current composite waveform of the time-domain signal with a predefined reference composite waveform, a waveform change equal to or greater than a threshold value is identified from the reference composite waveform.

3. The road surface condition determination device of claim 2, wherein the reference composite waveform is defined as a composite waveform of at least one of a time-domain signal measured at each set interval in the road section, and a time-domain signal measured in a previous road section adjacent to the road section.

4. The road surface condition determination device of claim 1, wherein the processor is configured to define road conditions that are determinable in the road section, and with respect to each defined road condition, learn the frequency characteristic of the source waveform, identified from the frequency-domain signal, separately for each vehicle speed interval.

5. A road surface condition determination method performed by a road surface condition determination device, the method comprising:
a conversion operation of converting a time-domain signal, obtained by measuring a tire friction sound of a vehicle in a road section, into a frequency-domain signal; and
a determination operation of comparing a frequency characteristic of a source waveform, identified from the frequency-domain signal, with a learning value to determine a road surface condition of the road section.

6. A road surface condition determination device comprising:
a memory comprising instructions; and
a processor configured to, by executing the instructions, determine a frequency band of interest for an audio signal measured in a road section based on whether a vehicle is driving in the road section, and determine a road surface condition of the road section from an audio feature extracted from the frequency band of interest.

7. The road surface condition determination device of claim 6, wherein the processor is configured to identify whether the vehicle is driving in the road section from an audio feature extracted from a specific frequency band, which is a predefined valid frequency band, among frequency bands of the audio signal.

8. The road surface condition determination device of claim 7, wherein the frequency band of interest is divided into different regions from the specific frequency band, based on a result of identifying whether the vehicle is driving.

9. The road surface condition determination device of claim 6, wherein the processor is configured to compare the audio feature extracted from the frequency band of interest with a learning value for each frequency band to determine the road surface condition of the road section, and
wherein the learning value for each frequency band comprises a deep learning-based training result obtained by learning an audio feature according to the road surface condition of the road section, separately for each frequency band of the audio signal.

10. A road surface condition determination device comprising:
a memory comprising instructions; and
a processor configured to, by executing the instructions, determine a road condition of a road section by using a multimodal model trained on road surface noise collected in the road section by using captured images, collected from multiple devices configured to photograph the road section, and road surface data, collected from an optical sensor configured to photograph the road section.

11. The road surface condition determination device of claim 10, wherein the processor is configured to generate the multimodal model by assigning a label, generated by synthesizing the captured images collected under multiple different road surface conditions with the road surface data and weather data at a collection time point, to road surface noise collected in the road section at the collection time point, and training the multimodal model on the labeled road surface noise.

12. The road surface condition determination device of claim 10, wherein the multiple devices are installed at regular intervals in the road section to photograph a designated road region of the road section, and
wherein the road surface noise collected in the road section is sound acquired by the multiple devices in the designated road region of the road section.

13. The road surface condition determination device of claim 10, wherein the processor is configured to finally determine a road surface condition through post-processing using each road surface condition prediction result, which is obtained from the multimodal model by inputting data on each road noise acquired for each designated road region of the road section into the multimodal model at a time of determining the road surface condition, and road surface data, which is acquired from the optical sensor at the time of determining the road surface condition.

14. The road surface condition determination device of claim 13, wherein the post-processing of the processor comprises weighted processing which:
increases a usage rate of the road surface data used in the final determination of the road surface condition as the consistency of road surface condition prediction results between adjacent road regions increases; and
decreases a usage rate of the road surface data used in the final determination of the road surface condition as the consistency of road surface condition prediction results between adjacent road regions decreases.
